(19) United States
(12) Patent Application Publication
(10) Pub. No.: US 2026/0295399 A1
(43) Pub. Date: Oct. 1, 2026

(54) VIDEO SMOOTHING BY SELECTIVE USE OF B-FRAMES

(71) Applicant: Sony Interactive Entertainment Inc., Tokyo (JP)

(72) Inventors: Christian Rickeby, Trabuco Canyon, CA (US); Torgeir Hagland, Santa Ana, CA (US)

(73) Assignee: Sony Interactive Entertainment Inc., Tokyo (JP)

(21) Appl. No.: 19/096,376

(22) Filed: Mar. 31, 2025

(51) Int. Cl. A63F 13/358

(52) U.S. Cl. CPC A63F 13/358; A63F 2300/534

(57) ABSTRACT

Methods, systems, and code for video games that can exploit opportunities to vary one or more parameters to change a compromise between a first characteristic and a second characteristic to improve overall game performance. In one example, an opportunity to compromise a first characteristic to improve a second characteristic can be detected as the beginning or occurrence of a noninteractive sequence or cutscene. A parameter that can be changed is the number of b-frames in a group of frames of encoded video data. A first characteristic, latency, can be compromised by the increase in b-frames, but latency might not be as important during a cutscene. A second characteristic, bandwidth utilization, can be reduced and thereby improved by the use of the increased number of b-frames.

### BACKGROUND

Video games can be an incredibly immersive form of entertainment. Whether played alone or in groups over the internet, video games can be challenging and engaging. For some games, player immersion can be enhanced with the inclusion of life-like characters, highly detailed virtual worlds, and other amazing enhanced graphical effects. Thus, what is needed are methods, systems, and code that can further improve video game graphics.

### BRIEF DESCRIPTION OF THE DRAWINGS

FIG. 1 illustrates a method of exploiting an opportunity to compromise a first characteristic to improve a second characteristic according to an embodiment of the present invention;

FIG. 2 illustrates a gaming system according to an embodiment of the present invention;

FIG. 3 illustrates a method of exploiting an opportunity to increase latency to improve a second characteristic according to an embodiment of the present invention;

FIG. 4 illustrates a method of utilizing b-frames in an embodiment of the present invention;

FIG. 5 illustrates a method of exploiting an opportunity to compromise latency to reduce bandwidth usage and improve picture quality according to an embodiment of the present invention;

FIG. 6 illustrates a method of compromising latency in steps according to an embodiment of the present invention;

FIG. 7 illustrates a method of exploiting an opportunity to compromise latency to reduce bandwidth usage and improve picture quality according to an embodiment of the present invention; and

FIG. 8 illustrates a simplified block diagram of a hardware system suitable for implementing a console or other computer system according to an embodiment of the present invention.

### DESCRIPTION OF ILLUSTRATIVE EMBODIMENTS

Embodiments of the present invention can provide methods, systems, and code that can improve video game graphics. In these embodiments, compromises can be made among different characteristics to provide an optimized result to a player. More specifically, embodiments of the present invention can vary these compromises in certain circumstances to improve overall game performance. For example, these and other embodiments of the present invention can utilize opportunities to vary one or more parameters to change a compromise between a first characteristic and a second characteristic to improve overall game performance. These opportunities can occur during game or game related content where the importance of a characteristic changes, becoming less or more important. When a first characteristic becomes less important, advantage can be taken of this reduction and more importance can be given to a second characteristic. When a first characteristic becomes more important, the importance given to a second characteristic can be reduced. That is, for some game and game-related content, characteristics can be reduced in importance in favor of other characteristics in order to gain an advantage. These and other embodiments of the present invention can implement and cease the exploitation of these opportunities in a gradual manner such that changes in game performance is not noticeable or is at least less noticeable.

In an illustrative embodiment of the present invention, an opportunity to compromise or degrade a first characteristic to improve a second characteristic can be detected. The opportunity can be the beginning or occurrence of a noninteractive sequence, which can be referred to colloquially as a cutscene. These noninteractive sequences can also be referred to storytelling sequences, visual narratives, or by other terms. These noninteractive sequences can be durations where the game program controls the displayed content and inputs from a player via a controller or other input device are ignored or limited. Other opportunities can include the opening of a menu, pausing of the game by a player, opening or closing credits, displaying a developer logo, or other game or game related events.

An opportunity to compromise or degrade a first characteristic to improve a second characteristic can be detected in various ways. A game program can provide code that an opportunity might begin. For example, an opportunity can be detected by receiving code from the game program that a cutscene is soon to begin. Where code is not provided by the game program, data gathered from previous gameplays can be analyzed to determine that a cutscene can begin shortly. For example, it can be known that when a player plays a game for the first time, a narrative sequence of a first duration will run. When a player plays this game for the first time, the opportunity afforded by the narrative sequence can be exploited. Other opportunities can be detected in other ways. These opportunities can be detected by various devices. For example, an opportunity can be detected by a server, console, or other gaming component.

The first characteristic and the second characteristic can be various characteristics. Also, these characteristics are typically not changed directly, rather they can often be changed due to changes in values of underlying parameters. The first characteristic and the second characteristic can include latency, bandwidth usage, power dissipation, quality parameter (QP), and others. The underlying parameters can include a number of bi-directional predicted frames (b-frames) used in a group of pictures, a number passes of encoding that are used, frame rate, resolution, and other parameters.

In an illustrative example, the underlying parameter can be a number of b-frames used in a group of pictures. The number of b-frames can be increased during an opportunity, which can increase latency but reduce bandwidth utilization and often improve picture quality. The number of b-frames can be decreased to decrease latency, though this can increase bandwidth utilization and might degrade picture quality.

It can be desirable to avoid fully exploiting an opportunity as soon as it arises. For example, it can be desirable to gradually compromise or degrade the first characteristic, such as latency, so as not to provide a discontinuous image to the player. As such, it can be useful to know how long the event that is creating the opportunity can be expected to last. For example, if the duration is very short, there might not be time to implement an embodiment of the present invention, whereas if the duration is long, an embodiment of the present invention can be more fully implemented. In the above example where the parameter is a number of b-frames used in a group of pictures, the number of b-frames used can be gradually increased and then decreased, for example in steps, to smooth the resulting video image provided to a player.

In another illustrative example, the underlying parameter can be a number passes a frame takes through an encoder. The number passes can be increased, which can increase latency but reduce bandwidth utilization and can improve picture quality. The number of passes can be decreased to decrease latency, though this can increase bandwidth utilization and can degrade picture quality.

These and other embodiments of the present invention can use other parameters to vary a relationship between two or more characteristics during certain opportunities. For example, where latency can be increased, a resolution of an image provided to a player can be increased. In this case, resolution can be a parameter that is increased during an opportunity, and where a first characteristic, latency, is increased while a second characteristic, picture quality, is improved.

In another example, where latency can be increased, a frame rate of an image stream provided to a player can be increased. In this case, frame rate can be a parameter that is increased during an opportunity, and where a first characteristic, latency, is increased while a second characteristic, picture quality, is improved.

In another example, the parameter frame rate of an image stream provided to a player can be increased. In this case, frame rate can be a parameter that is increased during an opportunity, and where a first characteristic, resolution, is decreased while a second characteristic, picture quality, for example during fast movement, is improved.

Again, cutscenes and other in-game and game related events can be opportunities to adjust a balance between two or more characteristics. One such opportunity can include a menu being selected by a player. When the opportunity of a menu being selected occurs, the frame rate can be lowered and the resolution can be increased, making the menu easier to read. Similarly, when a player pauses the game, the frame rate can be lowered and the resolution can be increased.

Other opportunities presented by the presence of an opening credit, developer logo, closing credit, or other such opportunity can be exploited. In these and other opportunities, commands from a player's controller can be ignored or limited. In these situations, latency can be increased to achieve a gain in bandwidth utilization, resolution, picture quality, or other characteristic. In some cases where commands from a controller are not ignored, they may be limited to fast forward, skip, and similar commands. Where latency is increased and a player selects a fast forward mode, a sudden change in latency might not be noticeable. In these cases, a parameter that increases latency, such as the number of b-frames, an increase in resolution or frame rate, or other parameter can be varied such that a first characteristic, latency, is compromised in favor of an improvement in a second characteristic, such as picture quality.

In another example, ray tracing can be invoked, or utilized to a higher degree, during cutscenes and other times where the latency it can cause has a diminished importance. In this case, the parameter can be ray-tracing turning on, or at least partially turning on. The first characteristic that is compromised or degraded can be latency and the second characteristic that can be improved can be image quality.

Various embodiments of the present invention can incorporate one or more of these and the other features described herein. A better understanding of the nature and advantages of the present invention can be gained by reference to the following detailed description and the accompanying drawings.

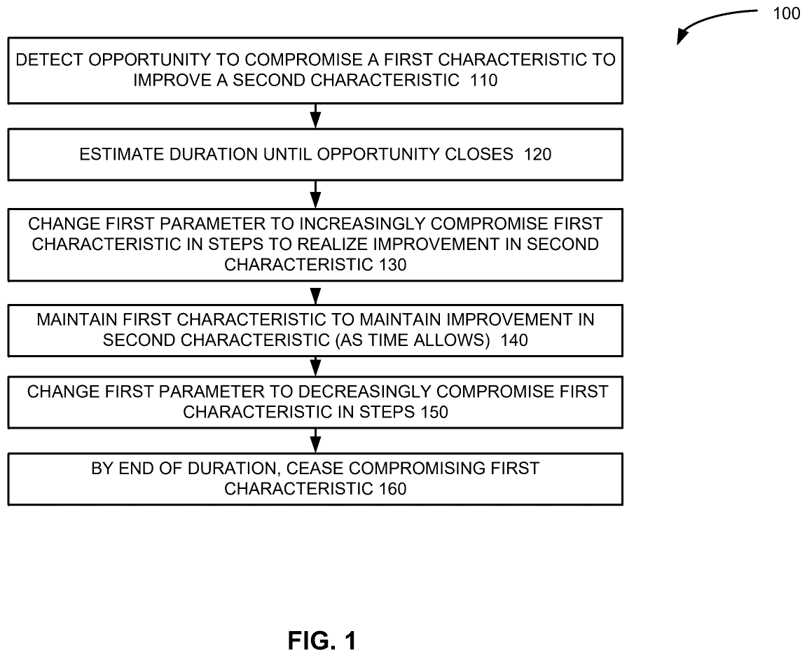

FIG. 1 illustrates a method of exploiting an opportunity to compromise a first characteristic to improve a second characteristic according to an embodiment of the present invention. In act 110 of method 100, an opportunity to compromise or degrade a first characteristic to improve a second characteristic can be detected. In these and other embodiments of the present invention, the opportunity can be the advent of a noninteractive sequence or cutscene. Again, these noninteractive sequences can also be referred to as storytelling sequences, visual narratives, or by other terms. These noninteractive sequences can be durations where the game program controls the displayed content and inputs from a player via a controller or other input device are ignored or limited. Other opportunities can include the opening of a menu, pausing of the game by a player, opening or closing credits, displaying a developer logo, or other game or game related events.

In these and other embodiments of the present invention, the first characteristic and the second characteristic can be various characteristics. These characteristics are typically not changed directly, rather they can be changed due to changes in values of underlying parameters. The first characteristic and the second characteristic can include latency, bandwidth usage, power dissipation, quality parameter (QP), and others. The underlying parameters can include a number of bi-directional predicted frames (b-frames) used in a group of pictures, a number passes of encoding that are used, frame rate, resolution, and other parameters.

In these and other embodiments of the present invention, an opportunity to compromise a first characteristic to improve a second characteristic can be detected in various ways. For example, an opportunity can be detected by receiving code from the game program that an opportunity is about to begin. Code can be received from game program that a cutscene is about to begin. In these and other examples, an opportunity can be determined by receiving code that a player has taken an action, such as when a menu has been selected by a player, or that a player has paused the game. Other code indicating that an opening credit, developer logo, closing credit, or other such opportunity can begin can be detected as used as an opportunity to compromise a first characteristic to improve a second characteristic.

In these and other embodiments of the present invention, code from the game program that an opportunity can arise might not be available, or it can be desirable to supplement such code. In these circumstances, the presence of an opportunity can be inferred. As an example, data gathered from previous gameplays can be analyzed to determine that a cutscene can begin. For example, it can be known that when a player plays a game for the first time, a narrative sequence of a first duration will run. When a player plays this game for the first time, the opportunity afforded by the narrative sequence can be exploited.

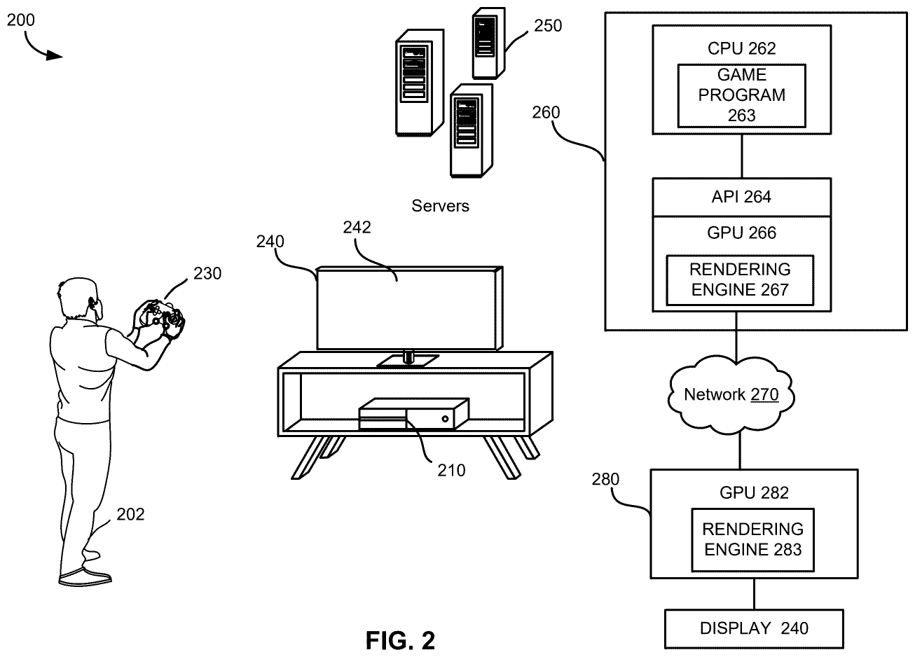

In these and other embodiments of the present invention, an opportunity can be detected by various devices. For example, an opportunity can be detected by servers 250, console 210, or other gaming component (both shown in FIG. 2.)

In these and other embodiments of the present invention, it can be desirable to avoid fully exploiting an opportunity as soon as it arises. For example, it can be desirable to gradually compromise or degrade the first characteristic so as not to provide a discontinuous image to the player. Accordingly, it can be useful to know how long the event that is creating the opportunity can be expected to last. For example, if the duration is very short, there might not be time to implement an embodiment of the present invention, whereas if the duration is long, an embodiment of the present invention can be more fully implemented. Accordingly, in act 120, a duration of the event that is creating the opportunity, or the duration until the opportunity closes, can be estimated. This estimation can be provided by code from the game program, by data gathered from previous game play, or from other sources.

In act 130, a first parameter can be changed such that the first characteristic can be compromised or degraded to realize an improvement in the second characteristic. For example, the first parameter can be changed such that a first characteristic of latency can be increased in order to improve a second characteristic, such as to decrease bandwidth utilization or improve picture quality. It can be jarring visually to change latency by a large amount in a short period. Accordingly, embodiments of the present invention can increase the first parameter and the resulting latency in steps to avoid the presentation of discontinuous images. The first characteristic latency can be varied by changing an underlying parameter, such as the number of b-frames used in a group of frames. Since data for b-frames relies on frames that have not occurred, an increase in the number of b-frames in a group of frames can increase latency. An increase in the number of b-frames in a group of frames can also improve the second characteristic, such as frame compression and reduce an amount of data sent from server 250 to console 210 or other gaming component (both shown in FIG. 2.)

Accordingly, increasing the underlying parameter that is the number of b-frames in a group of frames can compromise or degrade a first characteristic, such as latency, to improve a second characteristic, such as bandwidth usage or picture quality. Typically, a very low latency is desirable as this improves response time to a change in inputs from a player. But during a cutscene or other opportunity, latency is not as important. That is, since controller inputs are inactive or limited during a cutscene, latency from the beginning of a frame being generated until it is displayed has a reduced importance. At this time, latency can be compromised to achieve gains of other characteristics, such as reduced bandwidth utilization or improved picture quality. The change in the number of b-frames can be gradual and done in steps of equal or unequal sizes. Changing the number of b-frames in steps can avoid a sudden noticeable change in latency.

In act 140, the compromise to the first characteristic can be maintained to the extent possible, that is before time constraints no longer permit. In act 150, the compromise to the first characteristic can be drawn down, again by changing the first parameter in steps or other gradual method to avoid discontinuous images. The compromise to the first characteristic can end by the end of the expected duration of the opportunity in act 160.

Embodiments of the present invention can be utilized by various circuits in a gaming system. For example, reducing bandwidth utilization from servers in data centers to remote clients is desirable, as is improving picture quality. Accordingly, embodiments of the present invention are well-suited to use in a server in a cloud computing or data center, though the server can be a server running on a consumer console, a phone, or any device capable of carrying out the methods described. Embodiments of the present invention can also be employed in consoles, handheld devices, and other circuits in a gaming system. Examples are shown in the following figure.

FIG. 2 illustrates a gaming system according to an embodiment of the present invention. Gaming system 200 can include console 210, controller 230, and one or more servers 250. Console 210 and controller 230 can be at a first location, such as a player's house, while a server 250 can be at a cloud computing or data center, though a server 250 can be a server running on a consumer console, a phone, or any device capable of carrying out the methods described. In this example, monitor or television 240 can be included. Console 210 can provide video images to television 240. In these and other embodiments of the present invention, other displays, such as handheld devices that can include features of controller 230 along with a screen, a headset, or other display device can be used and can receive video images either directly from console 210 or servers 250.

Servers 250 can include server circuits 260. Server circuits 260 can include CPU 262 to execute game program 263. Game program 263 can provide graphics data over a graphics data bus to API 264 and can pass data to GPU 266, which can render the game with rendering engine 267. Graphics data can be encoded and sent over network 270 to client circuits 280.

Client circuits 280 can be located in various devices in these and other embodiments of the present invention. For example, a player can wear a headset (not shown) that can primarily act as a screen for console 210, the player can use television 240, the player can use a handheld device that includes a screen and functions of controller 230, or the player can use another type of display. In these situations, GPU 282 and rendering engine 283 can be located in console 210. Console 210 can receive encoded graphics data over network 270 and decode the graphics data for the headset, television, handheld device, or other screen.

In another example, the headset or handheld device can include client circuits 280 and console 210 can be bypassed. Encoded graphics data can be received from server circuits 260 over network 270 directly by the headset or handheld device. The headset or handheld device can connect to server circuits 260 over network 270. The headset or handheld device can process the received encoded graphics information and render graphics data using GPU 282 and rendering engine 283. Rendering engine 283 can then display the graphics image on a screen in the headset or on the handheld device.

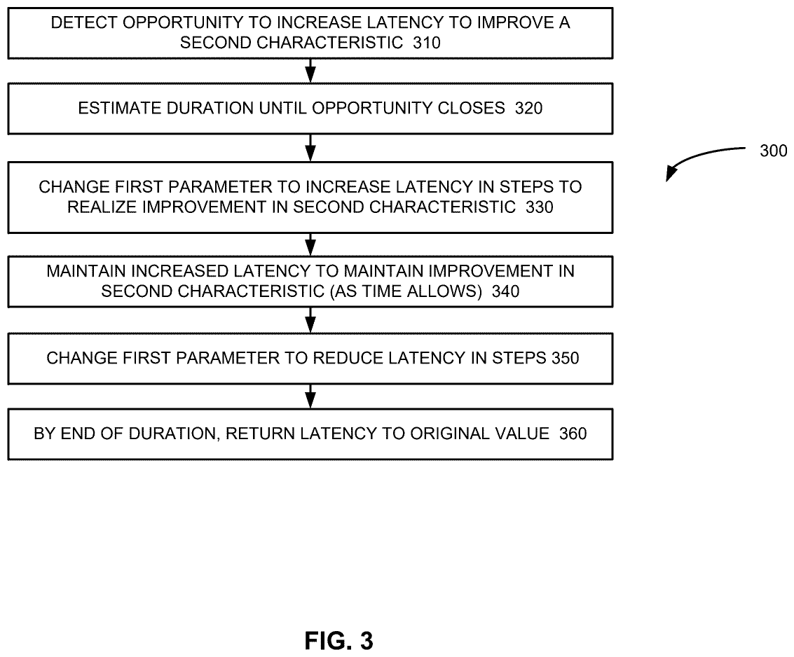

FIG. 3 illustrates a method of exploiting an opportunity to increase latency to improve a second characteristic according to an embodiment of the present invention. In act 310 of method 300, an opportunity to increase latency to improve a second characteristic can be detected. In these and other embodiments of the present invention, the opportunity can be the commencement of a cutscene. Other opportunities can include the opening of a menu, pausing of the game by a player, opening or closing credits, displaying a developer logo, or other game or game related events.

In these and other embodiments of the present invention, the second characteristic can be various characteristics. Latency and the second characteristic are typically not changed directly, rather they can be changed due to changes in values of underlying parameters. For example, latency is typically changed when an underlying parameter is changed and the result is a decrease or increase in latency. The second characteristic can include bandwidth usage, power dissipation, quality parameter (QP), and others. The underlying parameter can include a number of bi-directional predicted frames (b-frames) used in a group of pictures, a number passes of encoding that are used, frame rate, resolution, and other parameters.

In these and other embodiments of the present invention, an opportunity to increase latency to improve a second characteristic can be detected in various ways. For example, an opportunity can be detected by receiving code from the game program that an opportunity can begin. Code can be received from game program that a cutscene is about to, or can, begin. In these and other examples, an opportunity can be determined by receiving code that a player has taken an action, such as when a menu has been selected by a player, or that a player has paused the game. Other code indicating that an opening credit, developer logo, closing credit, or other such opportunity can begin can be detected as used as an opportunity to increase latency to improve a second characteristic.

In these and other embodiments of the present invention, code from the game program that an opportunity can arise might not be available, or it can be desirable to supplement such code. In these circumstances, the presence of an opportunity can be inferred. As an example, data gathered from previous gameplays can be analyzed to determine that a cutscene can begin. For example, it can be known that when a player plays a game for the first time, a narrative sequence of a first duration will run. When a player plays this game for the first time, the opportunity afforded by the narrative sequence can be exploited.

In these and other embodiments of the present invention, an opportunity can be detected by various devices. For example, an opportunity can be detected by servers 250, console 210, or other gaming component (both shown in FIG. 2.)

In these and other embodiments of the present invention, it can be desirable to avoid fully exploiting an opportunity as soon as it arises. For example, it can be desirable to gradually increase latency so as not to provide a discontinuous image to the player. Accordingly, it can be useful to know how long the event that is creating the opportunity to increase latency can be expected to last. For example, if the duration is very short, there might not be time to implement an embodiment of the present invention, whereas if the duration is long, an embodiment of the present invention can be more fully implemented. Accordingly, in act 320, a duration of the event that is creating the opportunity, or the duration until the opportunity closes, can be estimated. This estimation can be provided by code from the game program, by data gathered from previous game play, or from other sources.

In act 330, a first parameter can be changed such that latency can be increased to realize an improvement in the second characteristic. For example, the first parameter can be changed such that latency can be increased in order to decrease (improve) bandwidth usage or improve picture quality. It can be jarring visually to change latency by large amounts in a short period. Accordingly, embodiments of the present invention can increase the first parameter and thereby latency in steps to avoid the presentation of discontinuous images.

Latency can be varied by changing an underlying parameter such as the number of b-frames used in a group of frames. Since data for b-frames relies on frames that have not occurred, an increase in the number of b-frames in a group of frames can increase latency. An increase in the number of b-frames in a group of frames can also improve the second characteristic, such as frame compression and reduce an amount of data sent from server 250 to console 210 or other gaming component (both shown in FIG. 2.)

Accordingly, increasing the underlying parameter that is the number of b-frames in a group of frames can increase latency to improve a second characteristic, such as bandwidth usage or picture quality. The change in the number of b-frames can be gradual and done in steps of equal or unequal sizes. Changing the number of b-frames in steps can avoid a sudden noticeable change in latency.

In act 340, the increase in latency can be maintained. In act 350, latency can be reduced, for example in steps or other gradual method, to avoid discontinuous images. For example, the number of b-frames used in groups of pictures can be reduced in steps. Latency can return to an original value it had at the start of the opportunity by the end of the duration of the opportunity in act 360.

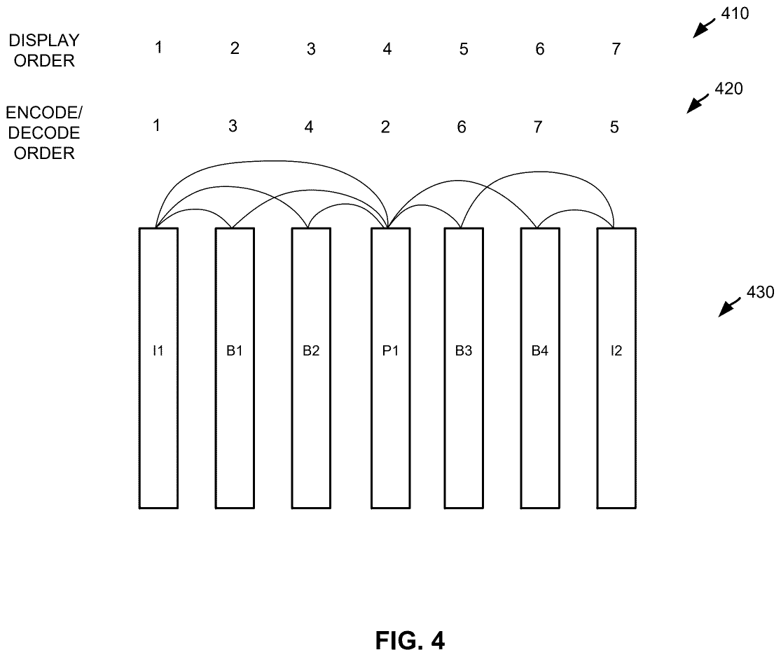

FIG. 4 illustrates a method of utilizing b-frames in an embodiment of the present invention. In this example, a display order 410 and an order of encoding and decoding 420 are shown for a group of frames 430. In this example, one predicted picture (p-frame) P1 can be used along with four b-frames. A keyframe or intra-coded picture (I-frame) I1 can be received by an encoder in server circuits 260 (shown in FIG. 2.) P-frame P1 can be encoded using the differences between P1 and I1. B-frame B1 can be encoded from differences between both B1 and I1 and between B1 and P1, (hence the term bidirectional predicted frames) while b-frame B2 can be encoded from differences between both B2 and I1 and between B2 and P1. In this arrangement, frame P1 is encoded, then frame B1 followed by frame B2 are encoded.

Following this, a second keyframe I2 can be received. B-frame B3 can be encoded from differences between both B3 and I2 and between B3 and P1, while b-frame B4 can be encoded from differences between both B4 and I2 and between B4 and P1. In this arrangement, frame I2 is received, then frame B3 followed by frame B4 are encoded.

In this example, P1 and B1 are encoded before B2 is encoded. Since P1 and B1 need to be encoded before B2, the inclusion of b-frames increases the latency of the encoding and decoding of the group of frames 430. While four b-frames are shown in this example, embodiments of the present invention can employ different numbers of b-frames and can change the number of b-frames used over time.

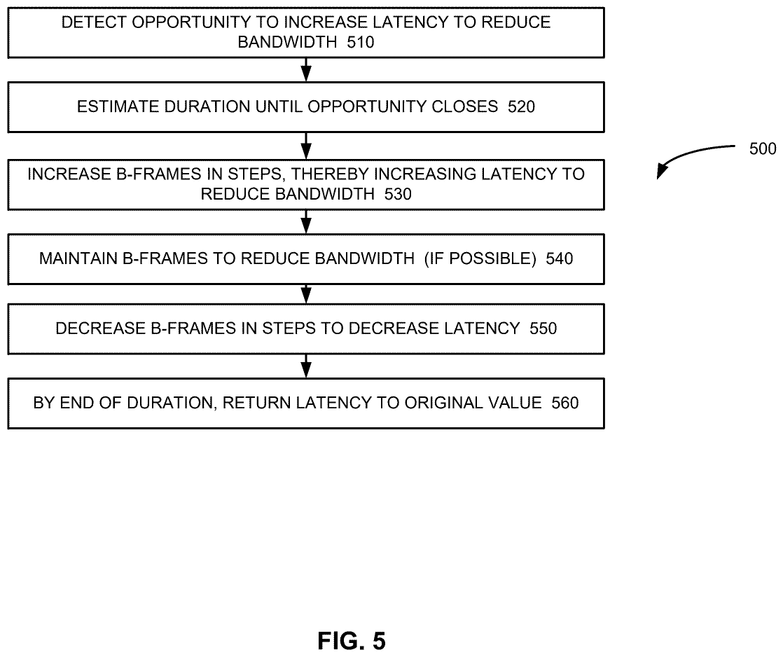

FIG. 5 illustrates a method of exploiting an opportunity to increase latency to reduce bandwidth usage according to an embodiment of the present invention. In act 510 of method 500, an opportunity to increase latency to improve (reduce) bandwidth usage can be detected. In these and other embodiments of the present invention, the opportunity can be a cutscene. Other opportunities can include the opening of a menu, pausing of the game by a player, opening or closing credits, displaying a developer logo, or other game or game related events. In these and other embodiments of the present invention, other characteristics, such as picture quality, can be improved in at least in some circumstances as latency is increased. Bandwidth usage is primarily discussed here for brevity.

Latency and bandwidth usage are typically not changed directly, rather they can be changed due to changes in values of underlying parameters. For example, latency is typically increased when an underlying parameter is changed and the result is a decrease or increase in latency. Similarly, bandwidth utilization is typically changed when an underlying parameter is changed and the result is a decrease or increase in bandwidth utilization. The underlying parameters can include a number of b-frames used in a group of pictures, a number passes of encoding that are used, frame rate, resolution, and other parameters.

In these and other embodiments of the present invention, an opportunity to increase latency to reduce bandwidth usage can be detected in various ways. For example, an opportunity can be detected by receiving code from the game program that an opportunity can begin. Code can be received from game program that a cutscene is about to, or can, begin. In these and other examples, an opportunity can be determined by receiving code that a player has taken an action, such as when a menu has been selected by a player, or that a player has paused the game. Other code indicating that an opening credit, developer logo, closing credit, or other such opportunity can begin can be detected as used as an opportunity to increase latency to reduce bandwidth utilization.

In these and other embodiments of the present invention, code from the game program that an opportunity can arise might not be available, or it can be desirable to supplement such code. In these circumstances, the presence of an opportunity can be inferred. As an example, data gathered from previous gameplays can be analyzed to determine that a cutscene can begin. For example, it can be known that when a player plays a game for the first time, a narrative sequence of a first duration will run. When a player plays this game for the first time, the opportunity afforded by the narrative sequence can be exploited.

In these and other embodiments of the present invention, an opportunity can be detected by various devices. For example, an opportunity can be detected by servers 250, console 210, or other gaming component (both shown in FIG. 2.)

In these and other embodiments of the present invention, it can be desirable to avoid fully exploiting an opportunity as soon as it arises. For example, it can be desirable to gradually increase latency so as not to provide a discontinuous image to the player. Accordingly, it can be useful to know how long the event that is creating the opportunity to increase latency can be expected to last. For example, if the duration is very short, there might not be time to implement an embodiment of the present invention, whereas if the duration is long, an embodiment of the present invention can be more fully implemented. Accordingly, in act 520, a duration of the event that is creating the opportunity, or the duration until the opportunity closes, can be estimated. This estimation can be provided by code from the game program, by data gathered from previous game play, or from other sources.

In act 530, the number of b-frames can be increased and latency can be increased to realize a reduction in bandwidth usage. For example, the number of b-frames used and the amount of latency can be increased in order to decrease bandwidth usage, and to possibly improve picture quality. But it can be jarring visually to change latency by a large amount in a short period. Accordingly, embodiments of the present invention can increase the number of b-frames and thereby latency in steps to avoid the presentation of discontinuous images.

In this example, the characteristic of latency can be varied by changing the number of b-frames used in a group of frames. Since data for b-frames relies on frames that have not occurred, an increase in the number of b-frames in a group of frames can increase latency. An increase in the number of b-frames in a group of frames can also improve frame compression and reduce an amount of data sent from server 250 to console 210 or other gaming component (both shown in FIG. 2) to reduce bandwidth utilization.

Accordingly, increasing the underlying parameter that is the number of b-frames in a group of frames can increase latency to reduce bandwidth usage or improve picture quality, or both. The change in the number of b-frames can be gradual and done in steps of equal or unequal sizes. Changing the number of b-frames in steps can help to avoid or reduce a sudden noticeable change in latency.

In act 540, the increase in latency can be maintained to extend the benefit of reduced bandwidth utilization, at least as permitted by time. In act 550, the latency can be reduced, for example in steps or other gradual method, to avoid discontinuous images. In act 560, latency can return to an original value by the end of the duration of the opportunity.

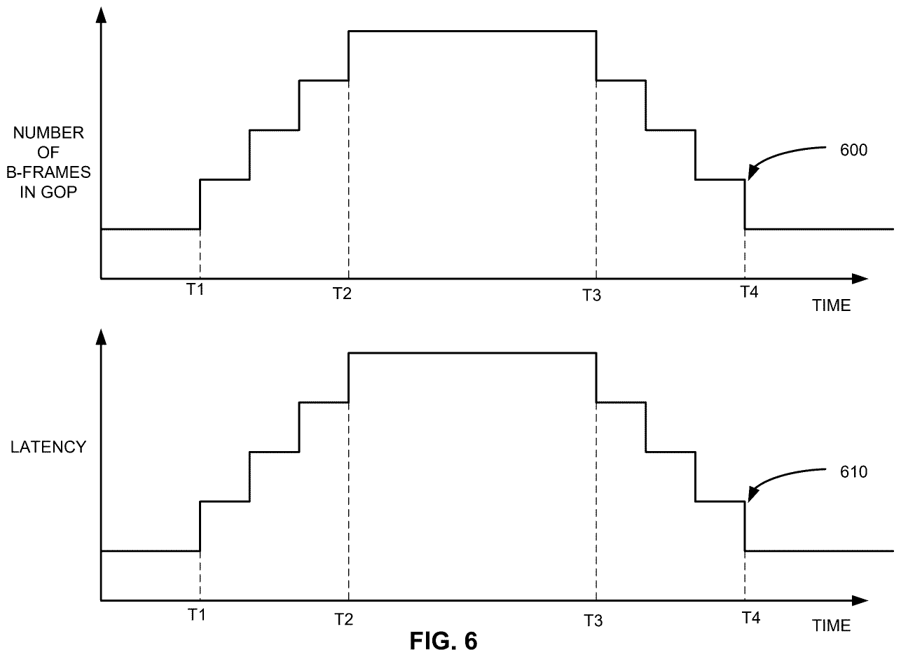

FIG. 6 illustrates a method of compromising latency in steps according to an embodiment of the present invention. In this example, the number of b-frames 600 in a group of frames can increase from a baseline (typically 0 or 1) at time T1. The time T1 can roughly correspond to the start of a cutscene or other opportunity to latency to improve a second characteristic. The increase in the number of b-frames can happen on a periodic basis. For example, the number of b-frames can increase every group of frames, after every occurrence of an i-frame, after a number of groups of frames, after a specific duration, such as 0.5 seconds, 1 second, 2 seconds, or other duration. The number of b-frames can increase until time T2. The steps can be equal or unequal. The times between steps can be equal or unequal. A maximum number of b-frames can be reached at time T2 due to memory limitations of the encoder or decoder. The maximum number of b-frames can be reached at time T2 because any further increase in the number of b-frames in each group of frames has only a minimal impact on bandwidth or picture quality. The maximum number of b-frames can be reached at time T2 because it is desirable to start reducing the number of b-frames in each group of frames starting at time T3. For example, time T3 can be the same time or close to the same time as T2.

At time T3, the number of b-frames in each group of frames can be decreased. The steps can be equal or unequal. The times between steps can be equal or unequal. For example, the number of b-frames can decrease every group of frames, after a number of groups of frames, after a specific duration, such as 0.5 seconds, 1 second, 2 seconds, or other duration. The number of b-frames can decrease until time T4. T4 can occur before the end of the cutscene or other event that provided an opportunity to compromise a first characteristic to improve a second characteristic.

In these and other embodiments of the present invention, the encoder or related circuits can determine how much latency can be added. For example, the amount of latency that can be added can be dependent on resolution, frame rate, and other information. The encoder can determine T4 based on the resolution, frame rate, expected duration, and other parameters. This can then determine an amount of latency that can be added.

In this example, latency 610 can track the number of b-frames in a group of frames. Changing the number of b-frames in a stepped, gradual manner can avoid presenting a player with a discontinuous appearing video image.

In this example, the number of b-frames in a group of frames can be varied in steps as shown. In some circumstances, the start or end of an opportunity to compromise a first characteristic to improve a second characteristic, such as a cutscene, can include a blackout to indicate a scene change or the passage of time. Where such a blackout occurs, an underlying parameter, such as the number of b-frames, can be more rapidly changed without being noticed by a player.

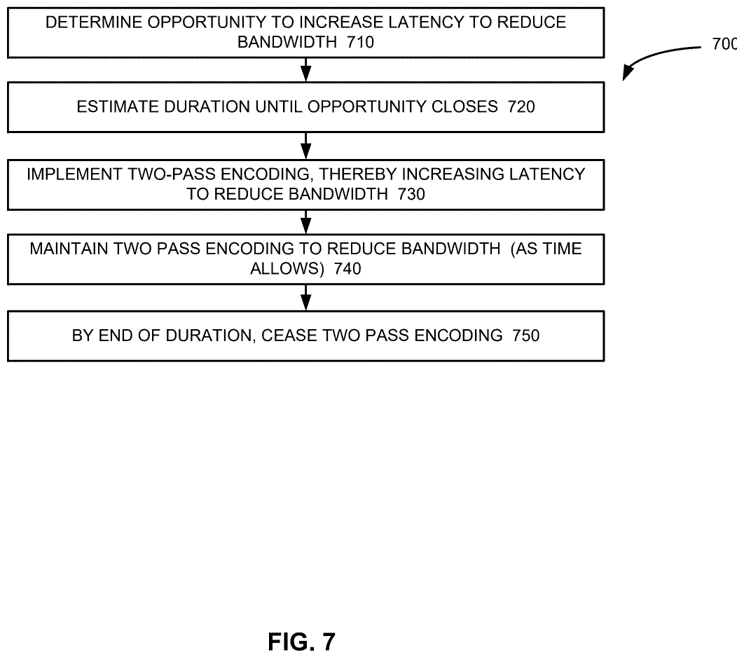

FIG. 7 illustrates a method of exploiting an opportunity to compromise or degrade a first characteristic, such as latency, to improve a second characteristic, such as a reduced bandwidth utilization or improvement in picture quality, according to an embodiment of the present invention. In the above examples, the parameter that is a number of b-frames can be increased at opportune times in order to reduce bandwidth usage or improve picture quality, or both, while increasing latency. In these and other embodiments of the present invention, other parameters can be varied that can increase latency and reduce bandwidth usage and improve picture quality or provide other benefits. For example, a type of encoding can be changed, where the change increases latency while reducing bandwidth usage.

In act 710 of method 700, an opportunity to increase latency to improve bandwidth usage can be detected. In these and other embodiments of the present invention, the opportunity can be a cutscene. Other opportunities can include the opening of a menu, pausing of the game by a player, opening or closing credits, displaying a developer logo, or other game or game related events. In these and other embodiments of the present invention, other characteristics, such as picture quality, can be improved at least in some circumstances as latency is increased. Bandwidth usage is primarily discussed here for brevity.

Latency and bandwidth usage are typically not changed directly, rather they can be changed due to changes in values of underlying parameters. For example, latency is typically changed when an underlying parameter is changed and the result is a decrease or increase in latency. Similarly, bandwidth usage is typically changed when an underlying parameter is changed and the result is a decrease or increase in bandwidth utilization. The underlying parameter in this example can be a number passes of encoding that are used. For example, using a second pass in two-pass or other multi-pass coding can reduce bandwidth utilization while increasing latency.

In these and other embodiments of the present invention, an opportunity to increase latency to reduce bandwidth usage can be detected in various ways. For example, an opportunity can be detected by receiving code from the game program that an opportunity can begin. Code can be received from game program that a cutscene is about to, or can, begin. In these and other examples, an opportunity can be determined by receiving code that a player has taken an action, such as when a menu has been selected by a player, or that a player has paused the game. Other code indicating that an opening credit, developer logo, closing credit, or other such opportunity can begin can be detected as used as an opportunity to increase latency to reduce bandwidth utilization.

In these and other embodiments of the present invention, code from the game program that an opportunity can arise might not be available, or it can be desirable to supplement such code. In these circumstances, the presence of an opportunity can be inferred. As an example, data gathered from previous gameplays can be analyzed to determine that a cutscene can begin. For example, it can be known that when a player plays a game for the first time, a narrative sequence of a first duration will run. When a player plays this game for the first time, the opportunity afforded by the narrative sequence can be exploited.

In these and other embodiments of the present invention, an opportunity can be detected by various devices. For example, an opportunity can be detected by servers 250, console 210, or other gaming component (both shown in FIG. 2.)

In these and other embodiments of the present invention, it can be useful to know how long the event that is creating the opportunity to increase latency can be expected to last. For example, if the duration is very short, there might not be time to implement measures, whereas if the duration is long, an embodiment of the present invention can be more fully implemented, or more than one embodiment can be simultaneously implemented. Accordingly, in act 720, a duration of the event that is creating the opportunity, or the duration until the opportunity closes, can be estimated. This estimation can be provided by code from the game program, by data gathered from previous game play, or from other sources.

In act 730, latency can be increased to realize a reduction in bandwidth usage. For example, latency can be degraded or increased in order to improve or decrease bandwidth usage, and to possibly improve picture quality. The characteristic of latency can be varied by varying an underlying parameter. In the above examples, the number of b-frames used in a group of frames can be increased. In this example, two-pass or other multi-pass encoding can be invoked. In these and other embodiments of the present invention, both an increase in the number of b-frames and two-pass encoding can be invoked to reduce bandwidth usage at the cost of increased latency.

In act 740, the increase in latency can be maintained as time permits to extend the benefit of reduced bandwidth utilization. In act 750, the increase in latency can be reduced or eliminated. The increase in latency can end by the end of the duration of the opportunity in act 760.

These and other embodiments of the present invention can use other parameters to vary a relationship between two or more characteristics during certain opportunities. For example, where latency can be increased, a resolution of an image provided to a player can be increased. In this case, resolution can be a parameter that is increased during an opportunity, and where a first characteristic, latency, is increased while a second characteristic, picture quality, is improved.

In another example, where latency can be increased, a frame rate of an image stream provided to a player can be increased. In this case, frame rate can be a parameter that is increased during an opportunity, and where a first characteristic, latency, is increased while a second characteristic, picture quality, is improved.

In another example, the parameter frame rate of an image stream provided to a player can be increased. In this case, frame rate can be a parameter that is increased during an opportunity, and where a first characteristic, resolution, is decreased while a second characteristic, picture quality, for example during fast movement, is improved.

Again, cutscenes and other in-game and game related events can be opportunities to adjust a balance between two or more characteristics. One such opportunity can include a menu being selected by a player. When the opportunity of a menu being selected occurs, the frame rate can be lowered and the resolution can be increased, making the menu easier to read. Similarly, when a player pauses the game, the frame rate can be lowered and the resolution can be increased.

Other opportunities presented by the presence of an opening credit, developer logo, closing credit, or other such opportunity can be exploited. In these and other opportunities, commands from a player's controller can be ignored or limited. In these situations, latency can be increased to achieve a gain in bandwidth utilization, resolution, picture quality, or other characteristic. In some cases where commands from a controller are not ignored, they may be limited to fast forward, skip, and similar commands. Where latency is increased and a player selects a fast forward mode, a sudden change in latency might not be noticeable. In these cases, a parameter that increases latency, such as the number of b-frames, an increase in resolution or frame rate, or other parameter can be varied such that a first characteristic, latency, is compromised in favor of an improvement in a second characteristic, such as picture quality.

In another example, ray tracing can be invoked, or utilized to a higher degree, during cutscenes and other times where the latency it causes has a diminished importance. In this case, the parameter can be ray-tracing turning on, or at least partially turning on. The first characteristic that is compromised can be latency and the second characteristic that can be improved can be image quality.

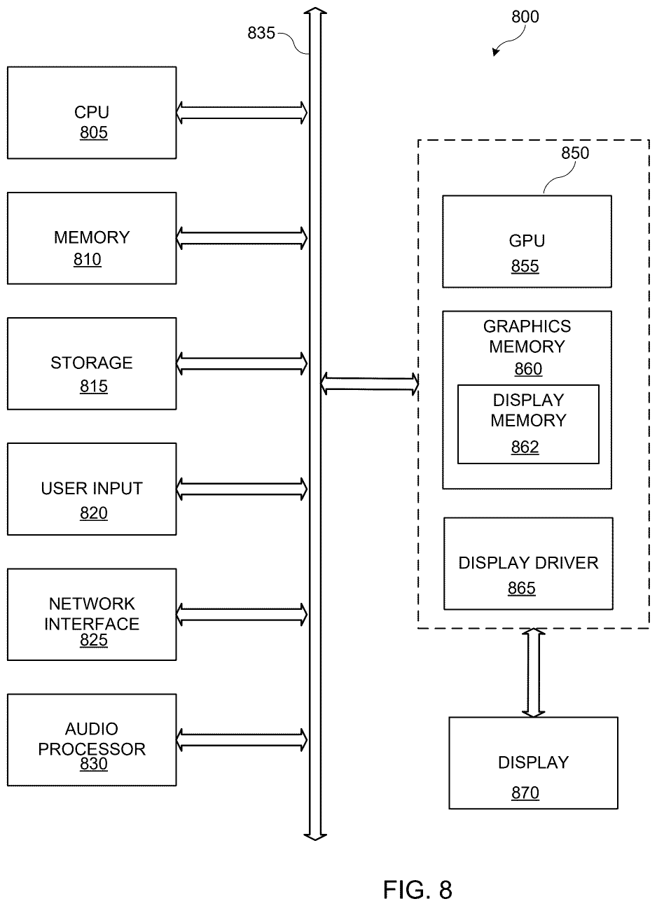

FIG. 8 illustrates a simplified block diagram of a hardware system suitable for implementing console 210 or other computer system according to an embodiment of the present invention. The computer system 800 can be, for example, a video game system, a personal computer (e.g., laptop or desktop computer), a handheld computer (e.g., a tablet or smartphone), a server computer, or other type of computer system. Computer system 800 can include a central processing unit (CPU) 805 capable of running software applications and optionally an operating system. CPU 805 can include one or more homogeneous or heterogeneous processing cores implemented in one or more integrated circuits. In some embodiments, CPU 805 can be implemented using one or more general-purpose microprocessors and/or microprocessors whose architectures are specifically adapted for highly parallel and computationally intensive applications, such as media and interactive entertainment applications. Memory 810 can store applications and data for use by CPU 805 and can include any combination of volatile and/or non-volatile memory components (e.g., DRAM, SRAM, etc.). Storage subsystem 815 can provide non-volatile storage for applications and data and may include various computer readable storage media such as fixed disk drives, removable disk drives, flash memory devices, and CD, DVD, Blu-ray, HD-DVD, or other optical storage devices. User input devices 820 can include devices that communicate user inputs from one or more users to computer system 800. Examples of user input devices 820 can include keyboards, mice, joysticks, touch pads, touch screens, still or video cameras, and/or microphones. In some embodiments, some or all of user input devices 820 can be incorporated into a handheld controller (e.g., controller 230 of FIG. 12) that communicates with other components of computer system 800 via a wired or wireless connection. Network interface 825 allows computer system 800 to communicate with other computer systems via an electronic communications network. Network interface 825 can include hardware and associated software to support wired and/or wireless communication over local area networks and/or wide area networks such as the Internet. An audio processor 830 can be adapted to generate analog or digital audio output signals from instructions and/or data provided by CPU 805, memory 810, and/or storage subsystem 815. The components of computer system 800, including CPU 805, memory 810, storage subsystem 815, user input devices 820, network interface 825, and audio processor 830 can be connected via a data bus 835.

A graphics subsystem 850 can also be connected to data bus 835 and thereby to other components of computer system 800. Graphics subsystem 850 can include a graphics processing unit (GPU) 855, a graphics memory 860, and a display driver 865. GPU 855 can operate as a co-processor to CPU 805 to accelerate operations associated with generating images for display. For example, GPU 855 can support 3D rendering operations to generate pixel data for output images from instructions and data defining the geometry, lighting, shading, texturing, motion, and/or camera parameters for a scene, for instance by executing shader programs and/or other rendering programs or operations. Graphics memory 860 can include a display memory 862 (e.g., a frame buffer) used for storing pixel data for each pixel of an output image. Graphics memory 860 (or portions thereof) can be integrated in the same device as GPU 855, connected as a separate device to GPU 855, and/or implemented within memory 810. Pixel data can be provided to display memory 862 directly from CPU 805. Additionally or instead, CPU 805 can provide GPU 855 with data and/or instructions defining the desired output images, from which GPU 855 can generate pixel data for one or more output images and write the pixel data to display memory 862. Display driver 865 can periodically output pixel data for an image from display memory 862 to a display device 870. Display device 870 can be any device capable of displaying visual information in response to a signal from display driver 865 that incorporates the pixel data; examples include CRT, LCD, plasma, LED, and OLED displays. Depending on implementation, display driver 865 can provide display device 870 with an analog or digital signal.

To implement system 200 or portions thereof, computer system 800 can store program code implementing any or all of the modules described above. Such program code can be stored in storage subsystem 815 and/or memory 810 and executed using CPU 805. A graphical user interface can be provided using a combination of display device 870 and user input received via user input devices 820; CPU 805 can execute program code to display the interface and process user input.

All processes described herein are also illustrative and can be modified. Operations can be performed in a different order from that described, to the extent that logic permits; operations described above may be omitted or combined; and operations not expressly described above may be added.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code for execution by the processor. Various blocks might or might not be reconfigurable depending on how the initial configuration is obtained. Embodiments of the present invention can be realized in a variety of apparatus including electronic devices implemented using a combination of circuitry and software.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein. A network may include both wired and wireless connections, including optical links. Many other examples are possible and will be apparent to those skilled in the art in light of this disclosure.

User interfaces for a given device can be implemented using various combinations of components. For instance, a graphical user interface may present a menu of options from which the user can select by operating an input device (e.g., mouse, joystick, buttons, etc.). A speech-based interface can be responsive to specific control words or phrases that the user may speak to change settings or invoke device functions. Some user interfaces can be implemented using switches, toggles, buttons, dials, or the like that the user can set to a desired position to control a device setting or function; feedback to the user can be provided via indicator lights, haptics, sounds, or other perceptual stimuli.

All numerical values and ranges provided herein are illustrative and may be modified. Unless otherwise indicated, drawings should be understood as schematic and not to scale. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Terms such as “approximately” or “substantially” should be understood to reflect manufacturing tolerance or expectations in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

It should also be understood that audio libraries and/or video segments may contain content that is protected by copyright. It is assumed that any use of such content would be in a manner consistent with applicable copyright restrictions.

Furthermore, embodiments can be implemented by hardware, software, firmware, middleware, microcode, hardware description languages, or any combination thereof. When implemented in software, firmware, middleware, or microcode, the program code or code segments to perform the necessary tasks can be stored in a computer-readable medium such as a storage medium. Processors can perform the necessary tasks.

It should be noted that the methods, systems, and devices discussed above are intended merely to be examples. It must be stressed that various embodiments can omit, substitute, or add various procedures or components as appropriate. For instance, it should be appreciated that, in alternative embodiments, the methods can be performed in an order different from that described, and that various steps can be added, omitted, or combined. Also, features described with respect to certain embodiments can be combined in various other embodiments. Different aspects and elements of the embodiments can be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments can be practiced without these specific details. For example, well-known circuits, processes, algorithms, structures, and techniques have been shown without unnecessary detail in order to avoid obscuring the embodiments.

Also, it is noted that the embodiments can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A computer-implemented method of generating images for a game, the method comprising, with a server:
determining an opportunity to compromise a first characteristic to improve a second characteristic;
in response to the opportunity, changing a first parameter to compromise the first characteristic and improve the second characteristic;
changing the first parameter to improve the first characteristic; and
cease compromising the first characteristic.

2. The method of claim 1 wherein the first parameter is changed in steps to compromise the first characteristic in steps.

3. The method of claim 2 wherein determining an opportunity to compromise a first characteristic to improve a second characteristic comprises determining an opportunity to increase latency to reduce bandwidth utilization.

4. The method of claim 3 wherein changing a first parameter to compromise the first characteristic comprises increasing a number of b-frames in group of pictures.

5. The method of claim 4 wherein the opportunity to comprise latency comprises the presence of a noninteractive sequence.

6. The method of claim 5 further comprising, before increasingly compromising the first characteristic, determining a length of the noninteractive sequence.

7. The method of claim 6 further comprising ceasing the compromising of the first characteristic before the end of the noninteractive sequence.

8. The method of claim 1 wherein determining an opportunity to compromise a first characteristic to improve a second characteristic comprises determining an opportunity to implement two-pass encoding to increase latency and reduce bandwidth utilization.

9. A system for generating images for a game, the system comprising:
a memory; and
a processor coupled to the memory and configured to:
determine an opportunity to compromise a first characteristic to improve a second characteristic;
in response to the opportunity, change a first parameter to compromise the first characteristic and improve the second characteristic;
change the first parameter to improve the first characteristic; and
cease compromising the first characteristic.

10. The system of claim 9 wherein the first parameter is changed in steps to compromise the first characteristic in steps.

11. The system of claim 10 wherein determining an opportunity to compromise a first characteristic to improve a second characteristic comprises determining an opportunity to increase latency to reduce bandwidth utilization.

12. The system of claim 11 wherein changing a first parameter to compromise the first characteristic comprises increasing a number of b-frames in group of pictures.

13. The system of claim 12 wherein the opportunity to comprise latency comprises the presence of a noninteractive sequence.

14. The system of claim 9 wherein determining an opportunity to compromise a first characteristic to improve a second characteristic comprises determining an opportunity to implement two-pass encoding to increase latency and reduce bandwidth utilization.

15. A computer-readable storage medium having stored therein program code instructions that, when executed by a processor in a computer system, cause the processor to perform a method comprising:
determining an opportunity to compromise a first characteristic to improve a second characteristic;
in response to the opportunity, changing a first parameter to compromise the first characteristic and improve the second characteristic;
changing the first parameter to improve the first characteristic; and
cease compromising the first characteristic.

16. The computer-readable storage medium of claim 15 wherein the first parameter is changed in steps to compromise the first characteristic in steps.

17. The computer-readable storage medium of claim 16 wherein determining an opportunity to compromise a first characteristic to improve a second characteristic comprises determining an opportunity to increase latency to reduce bandwidth utilization.

18. The computer-readable storage medium of claim 17 wherein changing a first parameter to compromise the first characteristic comprises increasing a number of b-frames in group of pictures.

19. The computer-readable storage medium of claim 18 wherein the opportunity to comprise latency comprises the presence of a noninteractive sequence.

20. The computer-readable storage medium of claim 15 wherein determining an opportunity to compromise a first characteristic to improve a second characteristic comprises determining an opportunity to implement two-pass encoding to increase latency and reduce bandwidth utilization.
